(19) United States
(12) Patent Application Publication
(10) Pub. No.: US 2018/0058517 A1
(43) Pub. Date: Mar. 1, 2018

(54) MULTI-MODE CLUTCH SYSTEM WITH DUAL BELL CRANKS

(71) Applicant: BorgWarner Inc., Auburn Hills, MI (US)

(72) Inventors: Calahan CAMPTON, Royal Oak, MI (US); John F. GUZDEK, Clarkston, MI (US); Jennifer KADLEC, West Bloomfield, MI (US)

(21) Appl. No.: 15/565,925

(22) PCT Filed: Apr. 7, 2016
(86) PCT No.: PCT/US2016/026388

§ 371 Date: Oct. 12, 2017

Related U.S. Application Data
(60) Provisional application No. 62/147,448, filed on Apr. 14, 2015.

(51) Int. Cl. F16D 41/08; F16D 23/12

(52) U.S. Cl. CPC F16D 41/084; F16D 2023/126; F16D 23/12

(57) ABSTRACT

The multi-mode clutch system (10) may include an actuator (14) and a first bell crank (42) and a second bell crank (46) that are operatively associated with the actuator (14). Furthermore, the first and second bell cranks (42, 46) may rotate about a first and second pivot point (34, 38) upon a movement of the actuator (14). The multi-mode clutch system (10) may further comprise a first pawl (86) and a second pawl (90) wherein the first bell crank (42) acts on the first pawl (86) and the second bell crank (46) acts on the second pawl (90). Moreover, the multiple modes of operation for engagement and disengagement between the first and second pawls (86, 90) and a driving member (74) according to different actuator (14) positions.

### CROSS-REFERENCE TO RELATED APPLICATION

This application is an International Patent Application claiming priority to US 35 U.S.C. § 119(e) to U.S. Provisional Patent Application No. 62/147,448 filed on Apr. 14, 2015.

### FIELD OF THE DISCLOSURE

The present disclosure relates generally to clutches for automotive transmissions and more particularly, relates to multiple bell cranks employed in the operation of such transmissions.

### BACKGROUND OF THE DISCLOSURE

An automotive vehicle typically includes an internal combustion engine containing a rotary crankshaft configured to transfer motive power from the engine through a driveshaft to turn the wheels. A transmission may be interposed between the engine and driveshaft components to selectively control torque and speed ratios between the crankshaft and driveshaft. In a manually operated transmission, a corresponding manually operated clutch may be interposed between the engine and transmission to selectively engage and disengage the crankshaft from the driveshaft to facilitate manual shifting among available transmission gear ratios.

In the case of a manually operated transmission, a manually operated clutch may be positioned between the internal combustion engine and the transmission to selectively engage and disengage the crankshaft from the driveshaft in order to facilitate shifting through the available transmission gear ratios. Alternatively, in an automatically operated transmission, a plurality of automatically actuated clutch units may be adapted to dynamically shift through the available gear ratios without requiring operator intervention. In some embodiments, the plurality of clutch units or clutch systems may be incorporated within transmission systems to facilitate the shifting through the gear ratios.

Furthermore, the various gears may be structurally comprised of sun gears, intermediate gears, such as planet or pinion gears supported by carriers, and outer ring gears. Moreover, specific transmission clutches may be associated with specific sets of selectable gears within the transmission to facilitate the desired ratio changes.

An exemplary transmission clutch system that is associated with first and reverse gear ratios may be positioned near the front of the transmission and closely adjacent to the engine crankshaft. The clutch may have a driving member and a driven member disposed circumferentially about the driving member and the driving and driven members may be configured to operate in multiple modes. Furthermore, in one non-limiting example, the driving member may be drivingly rotatable in only one direction. Alternatively or additionally, the driving member may be drivingly rotatable in a plurality of directions, however other modes and rotations may be possible. Moreover, the driving member may be selectively locked to the driven member via an engagement mechanism such as a roller, a sprag, a pawl, or other known engagement mechanisms. The rotation of the driving member may be effective to directly transfer rotational motion from the engine to the driveline.

In some transmission systems, the driven member may be fixed to an internal case or housing of an associated planetary member of the transmission. Under such circumstances, in a first configurational mode the driving member may need to be adapted to drive in one rotational direction, but freewheel, or overrun, in the opposite direction. Those skilled in the art will appreciate that overrunning may be particularly desirable under certain operating states, for example when a machine is traveling downhill or coasting. Under such a condition, the driven member may occasionally have a tendency to rotate faster than its associated driving member. Therefore, allowing the driving member to overrun the driven member may help provide protection against damage to the engine and/or transmission components.

In a second mode, such as when a machine may be in reverse gear, the engagement mechanisms may be adapted for actively engaging in both rotational directions of the driving member, thus not allowing for an overrunning condition in either direction. Alternatively, in a third mode the engagement mechanisms may be adapted such that they are disengaged in both rotational directions of the driving member and therefore allowing rotation in either direction.

Transmission systems may include a plurality of gear sets to accommodate multiple gear ratios, and therefore the reliability of actuators and other transmission components used for automatically switching clutch modules between and/or among various available operating modes is a consistent design concern. As a result, much effort has been directed to finding ways to assure transmission reliability at competitive costs.

### SUMMARY OF THE DISCLOSURE

In accordance with one aspect of the present disclosure a multi-mode clutch system is disclosed. The multi-mode clutch system may include an actuator and a first bell crank and a second bell crank that are operatively associated with the actuator. Furthermore, the first and second bell cranks may rotate about a first and second pivot point upon a movement of the actuator. The multi-mode clutch system may further comprise a first pawl and a second pawl wherein the first bell crank acts on the first pawl and the second bell crank acts on the second pawl. Moreover, the multi-mode clutch system may be configured to allow multiple modes of operation for engagement and disengagement between the first and second pawls and driving member according to different actuator positions.

In accordance with another aspect of the present disclosure a multi-mode clutch system with a first bell crank and a second bell crank is disclosed. The multi-mode clutch system may be configured to include an actuator and an armature. The multi-mode clutch system may also include a bracket that is fixedly attached to the actuator and the bracket may have a first pivot point and a second pivot point. Moreover, the first bell crank may be pivotally associated with the first pivot point and the second bell crank may be pivotally associated with the second pivot point and the first and second bell cranks may rotate about the first and second pivot points. The multi-mode clutch system may further include a first pawl and a second pawl wherein the first bell crank and the second bell crank may be respectively configured to act on the first and second pawls to allow for multiple modes of operation for engagement and disengagement between the first and second pawls and an driving member according to different actuator positions.

In accordance with yet another aspect of the present disclosure a method of operating a multi-mode clutch system having a first bell crank and a second bell crank may be configured to interact with a driving member to selectively provide multiple modes of operation is disclosed. The method may include forming an actuator having an armature and a pin and associating the actuator with the first and second bell cranks. Moreover, the first and second bell cranks may respectfully rotate about a first and second pivot point upon movement of the actuator. The method may further include, positioning a first pawl and a second pawl such that the first bell crank acts on the first pawl and the second bell crank acts on the second pawl. Furthermore, the actuator may be configured to selectively control multiple actuator movements on the first and second pawls to produce multiple modes of operation of the clutch system.

These and other aspects and features will be better understood when reading the following detailed description in conjunction with the accompanying drawings.

### BRIEF DESCRIPTION OF THE DRAWINGS

For further understanding of the disclosed concepts and embodiments, reference may be made to the following detailed description, read in connection with the drawings, wherein like elements are numbered alike, and in which:

FIG. 1 is a side view of a clutch assembly constructed in accordance with the present disclosure;

FIG. 2 is an enlarged side view of portion 2 of the clutch assembly of FIG. 1 constructed in accordance with the present disclosure;

FIG. 3 is a perspective view of portion 2 of clutch assembly of FIG. 1 constructed in accordance with the present disclosure;

FIG. 4 is an enlarged side view of portion 2 of the clutch assembly of FIG. I in a different mode than that of FIG. 1, constructed in accordance with the present disclosure;

FIG. 5 is an enlarged side view of portion 2 of the clutch assembly of FIG. 1 in a different mode than that of FIG. 1 or 4, constructed in accordance with the present disclosure;

FIG. 6 is a side view of the clutch assembly of FIG. 1 in a different mode than that of FIG. 4, or 5, constructed in accordance with the present disclosure;

FIG. 7 is a flow chart illustrating an exemplary process or method which may be practiced in accordance with an embodiment of the present disclosure.

It is to be noted that the appended drawings illustrate only typical embodiments and are therefore not to be considered limiting with respect to the scope of the disclosure or claims. Rather, the concepts of the present disclosure may apply within other equally effective embodiments. Moreover, the drawings are not necessarily to scale, emphasis generally being placed upon illustrating the principles of certain embodiments.

### DETAILED DESCRIPTION

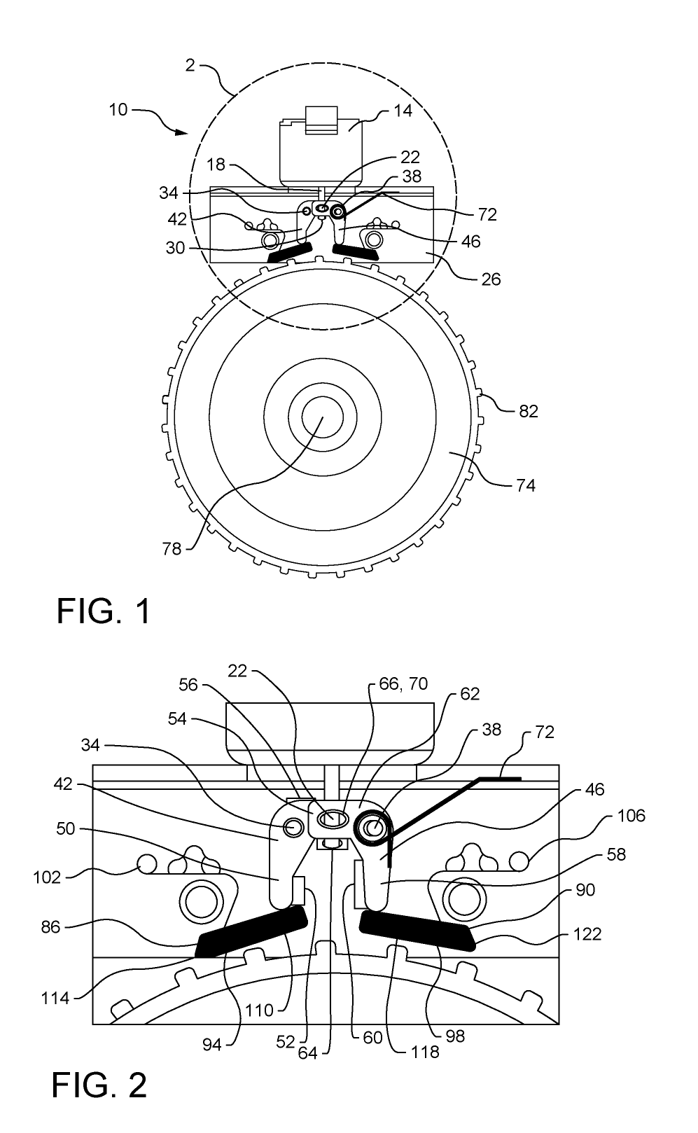

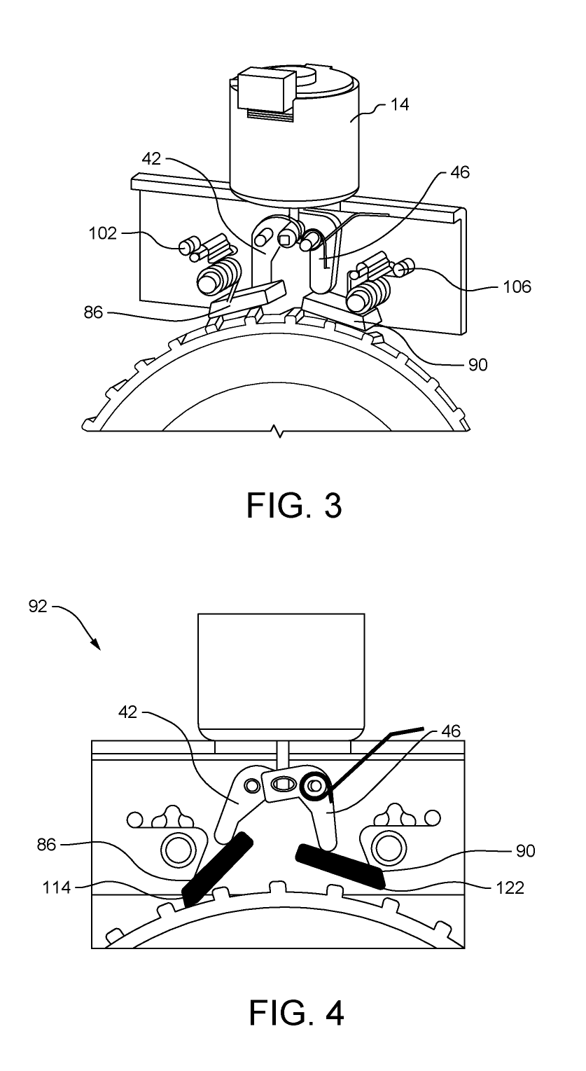

Turning now to the drawings, and with specific reference to FIGS. 1-3, a multi-mode clutch system constructed in accordance with the present disclosure is generally referred to by reference numeral 10. The multi-mode clutch system 10 is shown to include an actuator 14 including an armature 18. A pin 22 may be operatively associated with the armature 18. The actuator 14 may be a solenoid, magnetic device, hydraulic device, or other type of actuator 14. The pin 22 may be perpendicular to the armature 18, and may be attached to the armature 18 or pass through an opening in the armature 18. The armature 18 may be moved upon actuation by the actuator 14. In this manner, the pin 22 may move according to the motion of the actuator 14 and armature 18.

A bracket 26 may be attached to the actuator 14, and may include a slot 30. The pin 22 may be positioned in the slot 30, and may travel along a portion of the slot 30 as it is moved by the actuator 14. The bracket 26 may further include first and second pivot points 34, 38. A first bell crank 42 may pivot about the first pivot point 34, and a second bell crank 46 may pivot about the second pivot point 38. The first bell crank 42 may include a first pawl arm 50 and a first pin arm 54, while the second bell crank 46 may include a second pawl arm 58 and second pin arm 62. Additionally, the first bell crank 42 may include a first actuation point 66 and the second bell crank 46 may include a second actuation point 70. In one non-limiting example, the pin 22 is configured to interact with each of the first and second actuation points 66, 70 such that the interaction between the pin 22 and first and second actuation points 66, 70 produce the necessary movement of the first and second bell cranks 42, 46 for the desired engagement of the pawls 86, 90 and driving member 74. While, one non-limiting example is illustrated, other configurations of the pin 22 and first and second actuation points 66, 70 may be used depending upon the desired direction of motion and travel for the first and second bell cranks 42, 46. Furthermore, a bell crank return spring 72 may be incorporated to help bias the first and second bell cranks 42, 46 towards the actuator 14.

The multi-mode clutch system 10 may also include a driving member 74 rotatable around a rotation point 78. The driving member 74 may include a series of notches 82. A first pawl 86 and a second pawl 90 may be attached to the bracket 26, and may rotate about first and second pawl pivot points 94, 98 respectively. The pawls 86, 90 may rotate between open and locked positions. An open position may allow driving member 74 rotation in both directions, or in a particular direction, which may also be referred to as a ratcheting position. Additionally or alternatively, while in a locked position the driving member 74 rotation may not be allowed to rotate in a particular direction due to interference between one of the pawls 86, 90 and the notches 82. Moreover, a first pawl spring 102 may bias the first pawl 86 towards the locked position, and a second pawl spring 106 may bias the second pawl 90 towards the locked position.

More specifically, the first pawl 86 may include a first heel 110 and a first toe 114, and the second pawl 90 may include a second heel 118 and a second toe 122. Each heel 110, 118 may be actuated by respective bell cranks 42. 46 during operation, and each toe 114, 122 may be biased towards the locked position by each respective pawl spring 102, 106. Further, each toe 114, 122 may interfere with the notches 82 in a pawl 86, 90 locked position, thus preventing driving member 74 rotation in a direction.

In operation, the actuator 14 may move the armature 18 into various positions. In one embodiment, three positions are described, however a fewer or greater number of actuator 14 and/or armature 18 positions are possible. The multi-mode clutch system 10 may be arranged in such a way that different actuator 14 positions have different effects on the pawl 86, 90 positions. In the shown embodiment, at least three different actuator 14 positions allow for at least three different pawl 86, 90 positions and combinations, however a different number of positions is possible. Each actuator 14 position may correspond with a different clutch mode of operation for engagement and disengagement between the pawls 86, 90 and the driving member 74. While three actuator 14 positions are shown to correspond to three different modes of clutch operation, additional actuator 14 positions are possible which may produce additional modes of clutch operation.

In one position, as shown in FIG. 4, the clutch assembly is in a first mode of operation (92), where one pawl 86, 90 is in a locked position, and the other pawl 86, 90 is in an unlocked or open position. In such a mode (92), driving member 74 rotation is possible in one direction, but locked in the other.

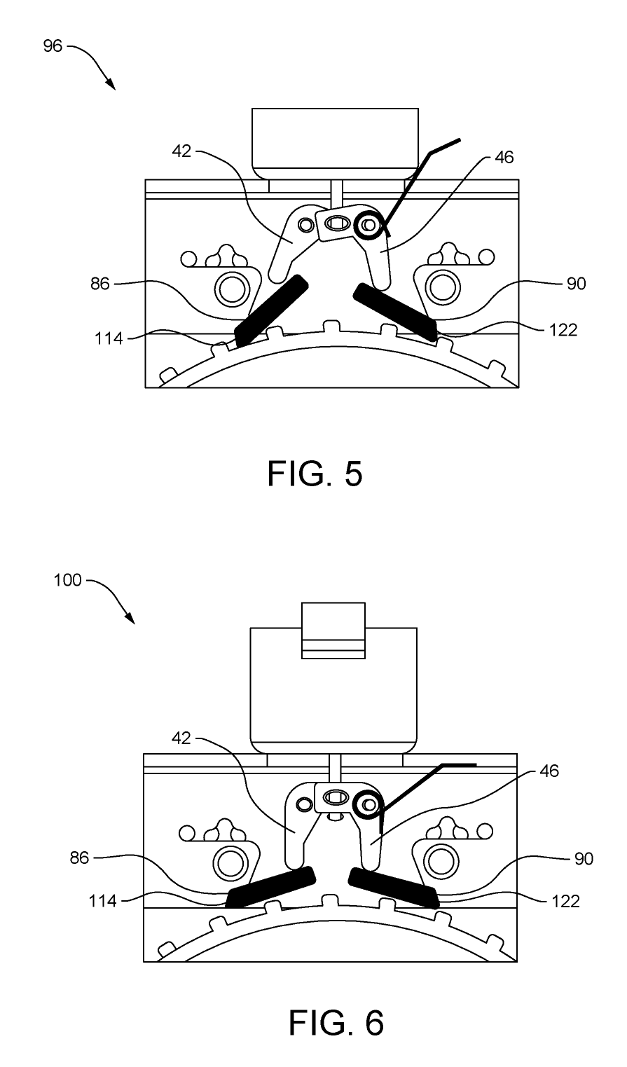

In another position, as shown in FIG. 5, the clutch assembly is in a second mode of operation (96), where both pawls 86, 90 are in a locked position. In such a mode (96), driving member 74 rotation is not possible in either direction.

In yet another position, as shown in FIG. 6, the clutch assembly is in a third mode of operation (100), where one pawl 86, 90 is in an open position, and the other pawl 86, 90 is also in an open position. In such a mode (100), driving member 74 rotation is possible in either direction. Additionally, in such an operation mode (100) one of the pawls 86, 90 may be in a ratcheting position such that the driving member 74 is free to rotate in one direction but not in the other direction.

A variety of approaches may be used to enable the multi-mode clutch system 10 to achieve multiple operating modes corresponding to different actuator 14 settings. As described above, three operating modes are illustrated to provide a set of non-limiting examples of the multi-mode clutch system 10, however additional modes of operation are possible. For example, the three or more operating modes could be achieved by varying the lengths (52, 60) of the first and second pawl arms 50, 58, or by varying the lengths (56, 64) of the first and second pin arms 54, 62. Alternatively, a combination of pawl arm 50, 58 and pin arm 54, 62 lengths (52, 54, 60, 64) could achieve multi-mode ability. Furthermore, the locations of the first and second pivot points 34, 38, or the first and second pawl pivot points 94, 98, or the relative locations thereof, may be configured to achieve multi-mode capability. Additionally, the shape, orientation or size of the pawls 86, 90 could be configured to enable multi-mode operation. Furthermore, each of the above-mentioned variables may be altered relative to each other to achieve additional modes of operation.

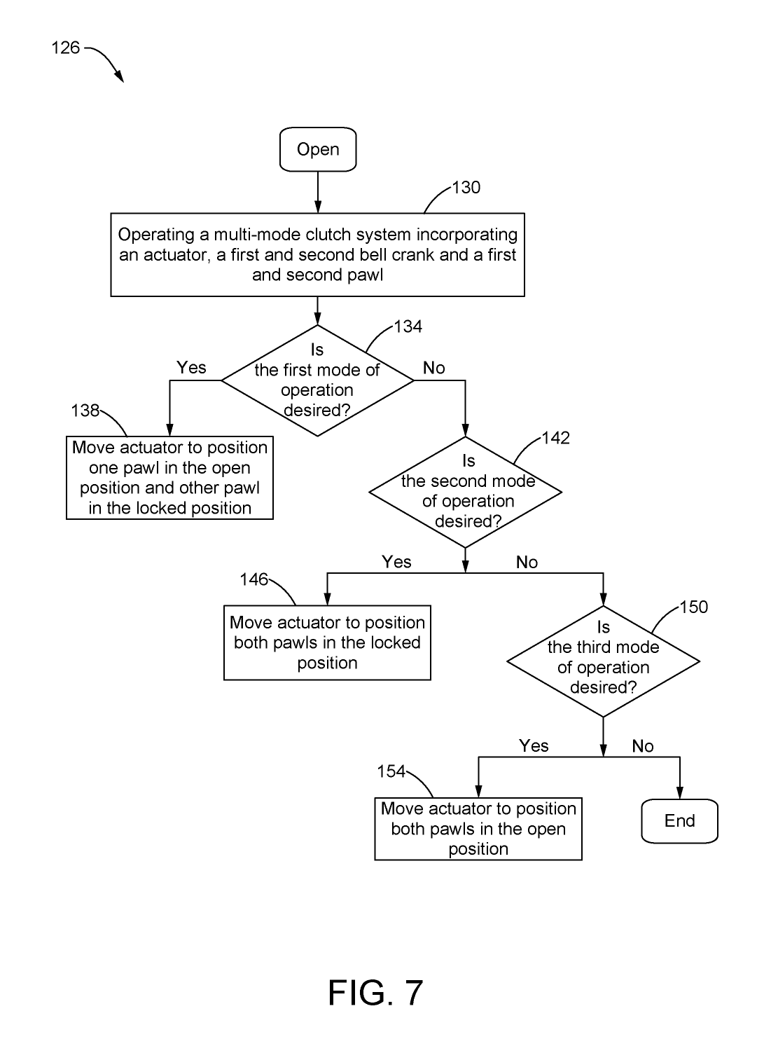

Referring now to FIG. 7 a method 126 of operating the multi-mode clutch system (10) is illustrated. In a first block (130), the multi-mode clutch system (10) may be operated such that it incorporates an actuator (14), a first bell crank (42), a second bell crank (46), a first pawl (86) and a second pawl (90). In a next block (134), the determination may be made whether a first mode of operation (92) of the multi-mode clutch system (10) is desired. If a first mode of operation (92) is made, then in the next block (138), the actuator (14) may be moved to position one pawl (86, 90) in an open position and the other pawl (86, 90) in a locked position. One non-limiting example of the first mode of operation (92) may be illustrated by actuator (14) and pawl positions (86, 90) as shown in FIG. 4

If the first mode of operation (92) is not desired then the determination may be evaluated in block 142 whether the second mode of operation (96) is desired. If the second mode of operation (96) is selected, then in block (146) the actuator (14) may be moved to position both pawls (86, 90) in a locked position. In one-non limiting example, FIG. 5 provides an illustration of the actuator (14) and pawl positions (86, 90) which may be used during the second mode of operation (96). Alternatively, if the second mode of operation (96) is not desired, then in the next block (150) the multi-mode clutch system (10) may make a determination whether the third mode of operation (100) is desired. If the third mode of operation (100) is selected, then in a next block (154) the actuator (14) may be moved to position both pawls (86, 90) in an open position. FIG. 6 may provide one non-limiting example of the actuator (14) and pawl (86, 90) positions in the third mode of operation (100).

It is to be understood that the foregoing is a description of one or more embodiments of the invention. However, the invention is not limited to the particular embodiment(s) disclosed herein. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

### INDUSTRIAL APPLICABILITY

In general, the multi-mode clutch system with dual bell cranks of the present disclosure may be applied on a variety of industrial applications, including but not limited to, automobiles, trucks, vans, off-road vehicles, agriculture equipment, construction equipment, and other equipment of the type incorporating internal combustion engines, automatic transmissions, and drivelines.

As disclosed herein, the multi-mode clutch system may incorporate an actuator having an armature that may be configured to interact with dual bell cranks. Furthermore, the actuator and the slotted dual bell cranks guided by a slot in a bracket may be configured to actuate a set of pawls. The multi-mode clutch system may allow for the translation of the linear motion provided by the actuator to engage and/or disengage the pawls into multiple modes on the clutch device. In some embodiments, springs may be utilized to aid with engagement and retraction of the pawls depending on the desired clutch mode. During operation, using the actuator and dual bell cranks in accordance with the present disclosure may create several non-limiting effects on the pawls. For example, in one mode of operation one of the pawls may be placed in an open mode and the other pawl may be positioned in a locked mode. As a result the multi-mode clutch system may be free to rotate in one direction and unable to rotate in the other direction. In another mode, it may be possible to place both pawls in a locked mode and as a result the multi-mode clutch system may restrict rotation in either direction. In yet another mode, both pawls may be positioned in an open position allowing the multi-mode clutch system to rotate, or freewheel, in either direction. While three separate modes are disclosed, additional modes of operation are certainly possible.

What is claimed is:

1. A multi-mode clutch system (10), comprising:
an actuator (14);
a first bell crank (42) and a second bell crank (46) operatively associated with the actuator (14), wherein the first and second bell cranks (42, 46) respectively rotate about a first and second pivot point (34, 38) upon a movement of the actuator (14); and
a first pawl (86) and a second pawl (90), wherein the first bell crank (46) acts on the first pawl (86), the second bell crank (46) acts on the second pawl (90), and the multi-mode clutch system (10) is configured to allow multiple modes of operation for engagement and disengagement between the first and second pawls (86, 90) and a driving member (74) according to different actuator (14) positions.

2. The multi-mode clutch system (10) of claim 1, wherein the actuator (14) includes an armature (18) and a pin (22) operatively associated with the armature (18), the pin (22) being perpendicular to the armature (18), and the pin (22) moving according to the actuation of the actuator (14) and the armature (18).

3. The multi-mode clutch system (10) of claim 2, wherein a bracket (26) having a slot (30) is attached to the actuator (14), the pin (22) being positioned within the slot (30), and configured to move along a portion of the slot (30).

4. The multi-mode clutch system (10) of claim 3, wherein the bracket (26) includes the first and second pivot points (34, 38) and the first bell crank (42) being pivotally associated with the first pivot point (34) and the second bell crank (46) being pivotally associated with the second pivot point (38).

5. The multi-mode clutch system (10) of claim 4, wherein the first bell crank (42) being configured with a first pawl arm (50), a first pin arm (54) and a first actuation point (66), the second bell crank (46) being configured with a second pawl arm (58), a second pin arm (62), and a second actuation point (70), and wherein the pin (22) being configured to interact with the first and second actuation points (66, 70).

6. The multi-mode clutch system (10) of claim 5, wherein a bell crank return spring (72) being configured to bias the first and second bell cranks (42, 46) towards the actuator (14).

7. The multi-mode clutch system (10) of claim 1, wherein the driving member (74) being rotatable around a rotation point (78)

8. A multi-mode clutch system (10) configured with a first bell crank (42) and a second bell crank (46), the multi-mode clutch system comprising:
an actuator (14) including an armature (18);
a bracket (26) fixedly attached to the actuator (14), the bracket (26) having a first pivot point (34) and a second pivot point (38), the first bell crank (42) pivotally associated with the first pivot point (34), the second bell crank (46) pivotally associated with the second pivot point (38) and the first and second bell cranks (12, 46) rotating about the first and second pivot points (34, 38) upon a movement of the actuator (14); and
a first pawl (86), and a second pawl (90), wherein the first and second bell cranks (42, 46) are configured to respectively act on the first and second pawls (86, 90) to allow for multiple modes of operation for engagement and disengagement between the first and second pawls (86, 90) and a driving member (74) according to different actuator (14) positions.

9. The multi-mode clutch system (10) of claim 8, wherein the first and second pawls (86, 90) are attached to the bracket (26), the first pawl (86) being configured to rotate about a first pawl pivot point (94), and the second pawl (90) being configured to rotate about a second pawl pivot point (98), the first and second pawl pivot points (94, 98) allowing the first and second pawls (86, 90) to rotate between an open position and a locked position.

10. The multi-mode clutch system (10) of claim 9, wherein the first pawl (86) includes a first heel (110) and a first toe (114), the second pawl (90) includes a second heel (118) and a second toe (122), the first and second heels (110, 118) being actuated by the first and second bell cranks (42, 46), and the first and second toes (114, 122) being biased towards the locked position by a first and second pawl spring (102, 106).

11. The multi-mode clutch system (10) of claim 10, wherein the driving member (74) being circumferentially configured with a plurality of notches (82) and the first and second toes (114, 122) interfere with the plurality of notches (82) placing the first and second pawls (86, 90) in the locked position.

12. The multi-mode clutch system (10) of claim 10, wherein the first bell crank (42) being configured with a first pawl arm (50) having a first pawl arm length (52) and a first pin arm (54) having a first pin arm length (56), the second bell crank (46) being configured with a second pawl arm (58) having a second pawl arm length (60) and a second pin arm (62) having a second pin arm length (64).

13. The multi-mode clutch system (10) of claim 12, wherein the first and second pawl arm lengths (52, 60) and the first and second pin arm lengths (56, 64) are configured with varying lengths to achieve multiple modes of operation for engagement and disengagement between the first and second pawls (86, 90) and a driving member (74) according to different actuator (14) positions.

14. The multi-mode clutch system (10) of claim 10, wherein the multiple modes of operation includes a first mode of operation (92) having one of the first and second pawls (86, 90) being in the open position and one of the first and second pawls (86, 90) being in the closed position such that the driving member (74) is rotatable in one direction and non-rotatable in the opposite direction, a second mode of operation (96) having the first and second pawls (86, 90) both being in the locked position such that the driving member (74) is non-rotatable in either direction, and a third mode of operation (100) where the first and second pawls (86, 90) both being in the open position.

15. A method (126) of operating a multi-mode clutch system (10) having a first bell crank (42) and a second bell crank (46) configured to interact with a driving member (74), to selectively provide multiple modes of operation, the method (126) comprising:
forming an actuator (14) including an armature (18) and a pin (22);
associating the first and second bell cranks (42, 46) with the actuator (14) such that the first and second bell cranks (42, 46) respectfully rotate about a first and second pivot point (34, 38) upon a movement of the actuator (14);
positioning a first pawl (86) and a second pawl (90) such that the first bell crank (46) acts on the first pawl (86) and the second bell crank acts on the second pawl (90); and
selectively controlling actuator (14) movements on the first and second pawls (86, 90) to produce multiple modes of operation.
